(19) United States
(12) Patent Application Publication
(10) Pub. No.: US 2015/0096146 A1
(43) Pub. Date: Apr. 9, 2015

(54) Device that maintains the open position of a window that is hinged at the bottom

(71) Applicant: Philip G. Roethig, Portland, OR (US)

(72) Inventor: Philip G. Roethig, Portland, OR (US)

(21) Appl. No.: 14/046,754

(22) Filed: Oct. 4, 2013

(51) Int. Cl. E05C 17/00; E05C 17/38

(52) U.S. Cl. CPC E05C 17/025; E05C 17/38
USPC 16/82

(57) ABSTRACT

The device that maintains the open position of a window that is hinged at the bottom is a secure, portable and easy-to-use device. It is manually inserted in the side opening of the window to block the window's closure. It is shaped in the form of a letter “Z” to lock itself with its two ends against the edge of the window and the edge of the window frame. The middle part of the “Z” is the crush-resistant block between the window and its frame that prevents the window's closure. Design dimensions ensure that the device will not twist and fall out of position. The device is made of special material for lightness and strength. The device is also used for doors that are hinged at the bottom.

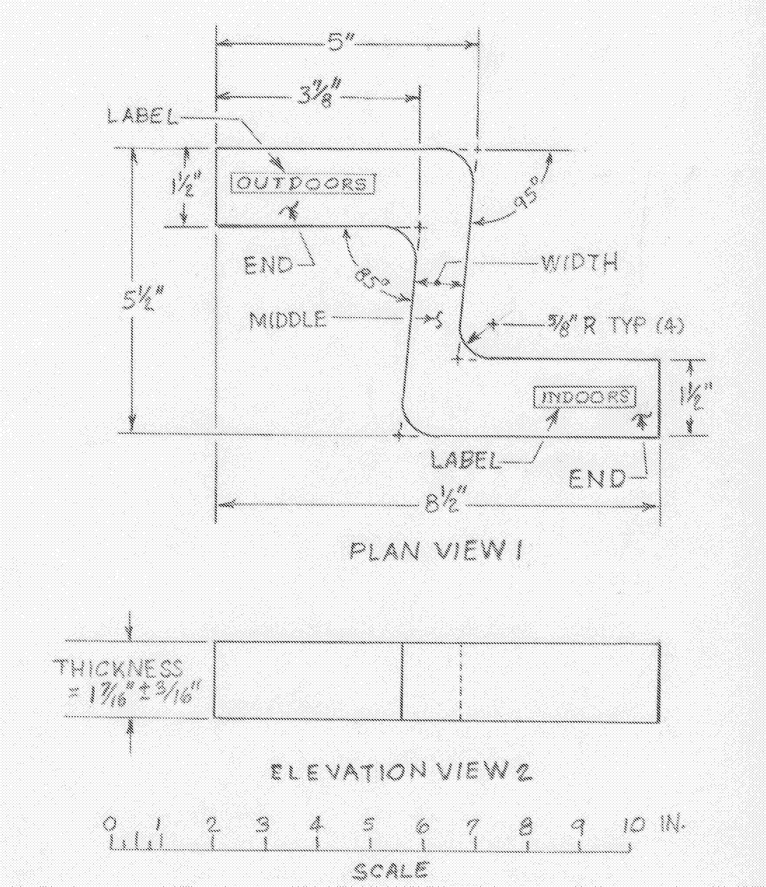

### CROSS-REFERENCE TO RELATED APPLICATIONS

Not Applicable

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### BACKGROUND OF THE INVENTION

A style of steel-casement windows used in many apartment buildings features hinges at the bottom of the window to allow limited opening at the top. This results in a maximum opening of the window near the ceiling and a v-shaped opening on each side that tapers to a point at the bottom of the window. Several hundred of these windows exist in the vicinity of the inventor in several apartment buildings.

The windows with bottom hinges are opened manually and stay in the open position approximately five degrees from vertical by the force of gravity on the window's displaced center of gravity.

This displacement force of gravity is insufficient to maintain an open position of the window under conditions of strong drafts in the room or strong winds outside. An additional device external to the window is required to maintain the open position under these conditions.

The potential problems involved with this additional device include: instability or accidental horizontal, rotational, or vertical displacement; weakness, breaking, or crushing from closure forces; possible contact causing fracture of the adjoining glass or denting of the metal frame; limited applicability or unsuitability for different installations; hardness that would mar the finish of the window parts; and complexity or difficulty to use.

In addition to the windows described above there exists exterior doors with bottom hinges that operate similarly to the windows. All references in this document and this patent application to windows with bottom hinges shall apply equally to doors with bottom hinges.

The inventor developed a portable device that is convenient to use and reliable in its operation.

### BRIEF SUMMARY OF THE INVENTION

The device that maintains the open position of a window that is hinged at the bottom is a “Z” shaped object made of lightweight materials. Its size is approximately six inches by nine inches by one and a half inches thick with dimensions matched to the commercially made windows in common use. Dimensions are shown in drawing 01.

The device is completely portable and is installed and removed manually without the use of tools. It is suitable for use in any subject window or door and on either the right or the left side opening.

To install the device the user holds it vertically by one end with the other end pointing up and inserts it halfway into the v-shaped side opening of the window so that the other end of the device is exterior to the window. The end that the user holds is labeled INDOORS and the other end is labeled OUTDOORS. These labels are shown in drawing 01 PLAN VIEW 1. The user turns the device to a horizontal position as shown in PLAN VIEW 1 and gently lowers it until it rests against the window edges near the bottom of the v-shaped opening. The device is then secure and needs no further attention.

To remove the device the user holds the end labeled INDOORS and lifts the device a few inches vertically. The user turns the device to a vertical position and pulls it inside. The window may now be closed.

The problem of instability is that of unintended displacement. It is resolved by two essential design factors: (1) the “Z” shape, and (2) the relationship of the width and the thickness of the middle portion of the device between the two ends. Width and thickness are referenced in drawing 01.

The “Z” shape represents two parallel ends that point in opposite directions and a connecting middle part that is 85 degrees from the ends. The ends and middle are referenced in drawing 01 PLAN VIEW 1. The angle is shown in PLAN VIEW 1. In the installed position the ends contact the edges of the window and the window frame respectively and the middle part provides the bearing surface between the moveable window and its window frame. The middle part resists the closure forces of the window, while the ends resist lateral displacement of the device and prevent it from falling in or out of the window.

The dimensions of the middle part of the device provide stability against turning by its installed position being lower in the v-shaped opening. The width of the device is smaller than its thickness and this allows a lower installed position. Turning away from a horizontal position to a vertical position would require uplift from a user. The designed dimensions thereby counteract the unintended twisting of the installed device from a horizontal to a vertical position. The vertical position is required only for installation and removal but the horizontal position is required for usage. The critical ratio of width to thickness of the middle part is 0.70 where width refers to the dimension in the plane of the ends and thickness refers to the dimension at 90 degrees to that plane or the thickness of the entire device. These dimensions are shown in drawing 01.

The problem of vertical displacement is resolved by the weight of the device pulling it downward into the window opening with the aid of friction against the window and the window frame.

The problem of weakness is resolved by using laminations of corrugated cardboard for the material of the device. The direction of corrugations in each layer of laminations alternates to provide a large crushing strength to weight ratio for the middle part of the device and a large bending strength for the arms of the device.

The problem of fracture is resolved by the use of cardboard which is a soft fiber material that would not crack glass or twist metal.

The problem of limited applicability is resolved by the “Z” shaped design that eliminates the need for additional attachments or devices or modifications to existing windows. The device is usable on all windows and doors of similar manufacture and is re-usable many times.

The problem of hardness is resolved by the use of cardboard that is a soft fiber material that would not scratch glass or metal.

The problem of complexity is resolved by the simple three-step process of installation: insert, turn and lower, and the three-step process of removal: lift, turn and remove.

The purpose of the device is to safely block open a tilting window that is subject to closure by wind.

### BRIEF DESCRIPTION OF THE SEVERAL VIEWS OF THE DRAWING

The attached drawing 01 shows the plan view of the device with dimensions for manufacture. PLAN VIEW 1 is the view of the plane of the ends and middle of the device in a horizontal position when installed.

Drawing 01 ELEVATION VIEW 2 shows a side view of the device with its thickness.

Drawing 01 shows the width and thickness of the middle part of the device as reference.

Drawing 01 PLAN VIEW 1 shows the labels OUTDOORS and INDOORS that are attached to the device for guidance to the user on installation. The labels are actually interchangeable as the device is reversible and either end can be installed in the other position.

### DETAILED DESCRIPTION OF THE INVENTION

The device is manufactured from laminated cardboard plates. Sheets of corrugated cardboard are glued together with the direction of each sheet's corrugations changing 90 degrees from the adjoining sheet. The total thickness of the final plate is shown in drawing 01 ELEVATION VIEW 2.

Each individual device is cut out of the cardboard plates using a full-scale template. The dimensions of the template are shown in Drawing 01 PLAN VIEW 1.

The device is spray painted, labeled, and varnished for durability.

The device is used in an open window when wind conditions may slam the window shut. Only one device per window is required.

The device is manually installed in the side opening of the window at the time of opening. The procedure is described above in BRIEF SUMMARY. Either side opening of the window can be used.

When the window must be closed, the device is manually removed as described above in BRIEF SUMMARY. The device is set aside for another use.

No other devices for this purpose are known to be available. Common usage may involve stuffing household objects into the window openings to maintain the openings.

The accidental closure of an open window slammed shut by the wind often involves a loud bang that damage the window. The noise of banging windows is generally disruptive.

This device provides a stable means of keeping a window open.

1. The device that maintains the open position of a window that is hinged at the bottom is made in the shape of a “Z” by which two parallel ends pointing in opposite directions are connected by a middle part at an angle of 85 degrees.

2. The ratio of the width of the middle part of the device to the thickness of the middle part is less than 1.00 and ideally 0.70 where width is measured in the plane of the ends and the middle part and thickness is the thickness of the device as shown in drawing 01 ELEVATION VIEW 2.

3. The device is made of laminated corrugated cardboard in which the direction of the corrugations alternate 90 degrees with each adjoining layer.

4. The dimensions are shown is drawing 01 for a common style of window and are adjusted otherwise for other styles as may be required.

5. Exterior doors that are hinged at the bottom similar to a window that is hinged at the bottom are also included in this application in every way that the window application is used.
